(19) United States
(12) Patent Application Publication
(10) Pub. No.: US 2007/0075801 A1
(43) Pub. Date: Apr. 5, 2007

(54) Waveguide conversion devie, waveguide rotary joint, and antenna device

(75) Inventors: Takeshi Okano, Omihachiman-shi (JP); Tomohiro Nagai, Nagaokakyo-shi (JP)

Correspondence Address: DICKSTEIN SHAPIRO LLP, 1177 AVENUE OF THE AMERICAS (6TH AVENUE), NEW YORK, NY, 10036-2714, US

(73) Assignee: MURATA MANUFACTURING CO., LTD., Nagaokakyo-shi (JP)

(21) Appl. No.: 10/575,498

(22) PCT Filed: Oct. 20, 2004
(86) PCT No.: PCT/JP04/15483

§ 371 Date: Sep. 26, 2006

(30) Foreign Application Priority Data
Oct. 24, 2003 (JP) 2003-364962

(51) Int. Cl. H01P 1/16; H01P 1/06

(52) U.S. Cl. 333/21 R; 333/251; 333/256

(57) ABSTRACT

A waveguide conversion device including a rectangular waveguide connected to a circular waveguide, and an unnecessary-wave suppression groove provided at a mode conversion part between the rectangular waveguide and the circular waveguide. The unnecessary-wave suppression groove prevents an unnecessary transmission mode from being excited at the mode conversion part between the rectangular waveguide and the circular waveguide.

### TECHNICAL FIELD

The present invention relates to a waveguide conversion device, a waveguide rotary joint, and an antenna device that are suitably used to connect, for example, a rectangular waveguide to a circular waveguide, these waveguides being designed for high frequency signals.

### BACKGROUND ART

In general, an antenna device is known as a waveguide conversion device, which includes a rectangular waveguide that has a rectangular cross-sectional shape and a circular waveguide that has a circular cross-sectional shape, these waveguides being connected to each other (for example, see Patent Document 1).

Patent Document 1: Japanese Unexamined Patent Application Publication No. 5-235603

In a conventional antenna device of this type, for example, a conoid aperture that functions as a radiator is provided at one end of a circular waveguide, and a rectangular waveguide that extends in the direction perpendicular to the circular waveguide is connected to the other end of the circular waveguide. When the aperture of the circular waveguide receives radio signals, the electromagnetic waves of the radio signals are transmitted from the circular waveguide to the rectangular waveguide and output to, for example, a peripheral circuit that is connected to the rectangular waveguide.

In this case, in the conventional art, for example, the transmission mode, for example, the TM₀₁ mode, of electromagnetic waves that transmit through the circular waveguide is converted to another transmission mode (for example, the TE₀₁ mode) at a connection part between the circular waveguide and the rectangular waveguide, and then the electromagnetic waves are transmitted through the rectangular waveguide.

In the aforementioned conventional art, the mode, for example, the TM₀₁ mode, of electromagnetic waves that transmit through the circular waveguide is converted to, for example, the TE₀₁ mode at the connection part between the circular waveguide and the rectangular waveguide, and then the electromagnetic waves transmit through the rectangular waveguide.

However, in this case, another unnecessary transmission mode, together with an intended transmission mode, is often excited in the waveguide in which the transmission mode is changed. Thus, in the conventional art, a problem exists, such that unnecessary resonance is generated by the unnecessary transmission mode when high frequency signals are transmitted between the rectangular waveguide and the circular waveguide, and signal loss is increased, which results in, for example, decreased transmission efficiency and degradation in signal characteristics.

### DISCLOSURE OF INVENTION

In view of the aforementioned problems in the conventional art, it is an object of the present invention to provide a waveguide conversion device, a waveguide rotary joint, and an antenna device, in which, at a connection part between a rectangular waveguide and a circular waveguide, an unnecessary transmission mode can be suppressed, signals can be stably transmitted in an intended transmission mode, and the transmission efficiency, signal characteristics, and the like can be improved.

To solve the aforementioned problems, according to the present invention, a waveguide conversion device includes a rectangular waveguide that has a rectangular cross-sectional shape, extends in a predetermined longitudinal direction, and transmits high frequency signals of the TE₁₀ mode, and a circular waveguide that has a circular cross-sectional shape, is connected to an H plane of the rectangular waveguide at right angles, and transmits high frequency signals of the TM₀₁ mode. An unnecessary-wave suppression groove is provided at a mode conversion part between the rectangular waveguide and the circular waveguide, the unnecessary-wave suppression groove preventing an unnecessary transmission mode from being excited in the circular waveguide when high frequency signals are transmitted between the waveguides.

According to the present invention, the unnecessary-wave suppression groove functioning as a reactance element is provided at the mode conversion part, which performs transmission mode conversion between the rectangular waveguide and the circular waveguide. Thus, in a case where high frequency signals are transmitted between the rectangular waveguide and the circular waveguide, even when another unnecessary transmission mode (for example, the TE₁₁ mode) is excited in addition to the TM₀₁ mode that is required in the circular waveguide, the unnecessary transmission mode can be selectively suppressed with the unnecessary-wave suppression groove, and only a necessary transmission mode can be stably transmitted.

Accordingly, for example, resonance can be prevented from being generated due to the unnecessary transmission mode in the circular waveguide, in which mode conversion is performed, by appropriately setting, for example, the dimensions, shape, and placement of the unnecessary-wave suppression groove in advance. As a result, signal conversion loss can be decreased, and, for example, the transmission efficiency and signal characteristics can be improved.

The mode conversion part represents a part at which the rectangular waveguide and the circular waveguide intersect each other and transmission mode conversion is performed. Thus, the mode conversion part includes, in addition to a connection part between the rectangular waveguide and the circular waveguide, for example, parts, in which transmission mode conversion is performed, that extend from the connection part in the directions (the signal transmission directions) of the axes of the individual waveguides.

Moreover, in the present invention, the unnecessary-wave suppression groove is preferably provided in either one or both of the rectangular waveguide and the circular waveguide and extends in a direction that is perpendicular to an electric field component of the TE₁₁ mode in the circular waveguide that is an unnecessary transmission mode so as to have a length of one half or more than one half of the length of one wave of the high frequency signals.

In this arrangement, for example, the unnecessary-wave suppression groove can be provided in either one or both of the rectangular waveguide and the circular waveguide, and an unnecessary transmission mode can be stably suppressed by appropriately setting the placement of the unnecessary-wave suppression groove. Moreover, the unnecessary-wave suppression groove extends in a direction that is perpendicular to an electric field component of the unnecessary TE₁₁ mode so as to have a length of one half or more than one half of the length of one wave of the high frequency signals. Thus, for example, a transmission state can be achieved, in which the TE₁₀ mode of electromagnetic waves that transmit through the rectangular waveguide matches only the TM₀₁ mode required in the circular waveguide and does not match the unnecessary TE₁₁ mode. Accordingly, a strong effect of suppressing the unnecessary transmission mode can be achieved.

Moreover, in the present invention, the unnecessary-wave suppression groove may be provided in the rectangular waveguide at a position corresponding to the axis of the circular waveguide.

In this arrangement, for example, the unnecessary-wave suppression groove can be disposed with parts that constitute the rectangular waveguide. Thus, the part shape, structure, and the like of the circular waveguide that is not provided with the unnecessary-wave suppression groove can be simplified, the circular waveguide can be readily formed, and the productivity in this case can be high compared with the productivity in a case where both of the waveguides are provided with the unnecessary-wave suppression groove.

Moreover, in the present invention, the unnecessary-wave suppression groove may be provided in the circular waveguide.

In this arrangement, for example, the unnecessary-wave suppression groove can be disposed with parts that constitute the circular waveguide. Thus, the part shape, structure, and the like of the rectangular waveguide that is not provided with the unnecessary-wave suppression groove can be simplified, the rectangular waveguide can be readily formed, and the productivity can be improved.

Moreover, in the present invention, an alignment part may be provided between the rectangular waveguide and the circular waveguide, the alignment part being inserted into a part of the unnecessary-wave suppression groove when the waveguides are connected to each other to align the rectangular waveguide with the circular waveguide.

In this arrangement, the rectangular waveguide and the circular waveguide can be connected to each other so that these waveguides are accurately aligned with each other by, for example, inserting the alignment part that is provided in the circular waveguide into a part of the unnecessary-wave suppression groove that is provided in the rectangular waveguide. Thus, a waveguide conversion device that has accurate dimensions can be readily fabricated through the use of a part of the unnecessary-wave suppression groove, and effect of suppressing an unnecessary transmission mode can be improved. Alternatively, for example, even in a case where the alignment part is provided in the rectangular waveguide and the unnecessary-wave suppression groove is provided in the circular waveguide or a case where the alignment part is formed with a separate part and inserted into both of the rectangular waveguide and the circular waveguide, the same advantages as described above can be achieved, such that, for example, a waveguide conversion device that has accurate dimensions can be readily fabricated.

Moreover, a waveguide rotary joint may be provided, which includes two pieces of the waveguide conversion device according to the present invention. The circular waveguides of the individual waveguide conversion devices are disposed on the same axis and connected to each other so that the circular waveguides are rotatable.

In this case, the waveguide rotary joint includes two pieces of the waveguide conversion device that are connected to each other so that the waveguide conversion devices are rotatable. Thus, the circular waveguides of the individual waveguide conversion devices can be disposed on the same axis and connected to each other so that the circular waveguides are rotatable, and the circular waveguides can convert in a satisfactory condition the transmission mode of signals between the circular waveguides and the individual rectangular waveguides through the use of the unnecessary-wave suppression grooves. In this case, the electric field component of the TM₀₁ mode that transmits through the circular waveguides is symmetric with respect to the axis (the center of rotation) of the circular waveguides. Thus, even when the two circular waveguides rotate with respect to each other with their centers on the axis, the TM₀₁ mode can be stably transmitted between the circular waveguides. Thus, the rectangular waveguides of the individual waveguide conversion devices can smoothly transmit high frequency signals therebetween with the rectangular waveguides rotating with respect to each other. Accordingly, a highly versatile waveguide rotary joint can be implemented, in which the signal transmission loss is small.

Moreover, an antenna device may be provided, which includes two pieces of the waveguide conversion device according to the present invention. The circular waveguides of the individual waveguide conversion devices are disposed on the same axis and connected to each other so that the circular waveguides are rotatable, and either of the waveguide conversion devices includes a radiator for wireless communication.

In this arrangement, the antenna device includes two pieces of the waveguide conversion device that are connected to each other so that the waveguide conversion devices are rotatable. Thus, for example, the radiator of the waveguide conversion device at one side can be rotated with respect to the rectangular waveguide of the waveguide conversion device at the other side. In this state, the radiator at the one side can be stably connected to the rectangular waveguide at the other side with the circular waveguides, the unnecessary-wave suppression grooves, and the like. Thus, for example, radio signals can be smoothly transmitted and received by the rectangular waveguide of the waveguide conversion device at the other side while the directivity of the radiator is being changed in the rotation direction. Accordingly, a highly versatile rotary antenna device can be implemented, in which the signal transmission loss is small.

### BRIEF DESCRIPTION OF THE DRAWINGS

FIG. 1 is a perspective view of a waveguide conversion device according to a first embodiment of the present invention.

FIG. 2 is a sectional view of the waveguide conversion device as viewed from the direction indicated by arrows II-II in FIG. 1.

FIG. 3 is a sectional view of the waveguide conversion device as viewed from the direction indicated by arrows III-III in FIG. 1.

FIG. 4 is a perspective view showing as a comparative example a state of signal transmission in a case where no unnecessary-wave suppression groove is provided.

FIG. 5 is a perspective view of a waveguide conversion device according to a second embodiment of the present invention.

FIG. 6 is a sectional view of the waveguide conversion device as viewed from the direction indicated by arrows VI-VI in FIG. 5.

FIG. 7 is a perspective view of a waveguide conversion device according to a third embodiment of the present invention.

FIG. 8 is a sectional view of the waveguide conversion device as viewed from the direction indicated by arrows VIII-VIII in FIG. 7.

FIG. 9 is an exploded perspective view of a rectangular waveguide and a circular waveguide before the rectangular waveguide and the circular waveguide are assembled.

FIG. 10 is a plan view showing only the rectangular waveguide.

FIG. 11 is an illustration of characteristic lines of conversion loss and reflection loss when the waveguide conversion devices perform mode conversion.

FIG. 12 is a perspective view of a waveguide conversion device according to a fourth embodiment of the present invention.

FIG. 13 is a sectional view of the waveguide conversion device as viewed from the direction indicated by arrows XIII-XIII in FIG. 12.

FIG. 14 is an exploded perspective view of a waveguide conversion device according to a fifth embodiment of the present invention before the waveguide conversion device is assembled.

FIG. 15 is a sectional view of the rectangular waveguide and the circular waveguide, shown in FIG. 14, which are assembled as viewed from the same position as in FIG. 8.

FIG. 16 is a sectional view of a waveguide rotary joint according to a sixth embodiment of the present invention.

FIG. 17 is a sectional view of an antenna device according to a seventh embodiment of the present invention.

FIG. 18 is a sectional view of a waveguide conversion device according to a first modification of the present invention.

FIG. 19 is a sectional view of a waveguide conversion device according to a second modification of the present invention.

FIG. 20 is a sectional view of a waveguide conversion device according to a third modification of the present invention.

### REFERENCE NUMERALS

1, 11, 21, 31, 41, 53, 58 waveguide conversion device

2, 22, 32, 54, 54′, 59 rectangular waveguide

2A, 2B, 2C, 2D, 2E, 4A tube wall

3 aperture

4, 26, 35, 42, 55, 60 circular waveguide

5, 5′, 5″, 12, 27, 36, 56, 61 unnecessary-wave suppression groove

6, 13, 28 horizontal groove

7, 14, 29 vertical groove

6A, 7A, 13A, 14A, 24A, 28A, 34A bottom surface

23, 33 waveguide part

24, 34 long groove

24B, 34B side surface

24C, 34C end surface

24D, 29A concave curved surface

25 cover plate

26A, 35A, 42A circular hole

43 fitting protrusion (alignment part)

51 waveguide rotary joint

52, 52′, 57 joint part

62 choke

71 antenna device

72 radiator

### BEST MODE FOR CARRYING OUT THE INVENTION

A waveguide conversion device, a waveguide rotary joint, and an antenna device according to embodiments of the present invention will now be described in detail with reference to the attached drawings.

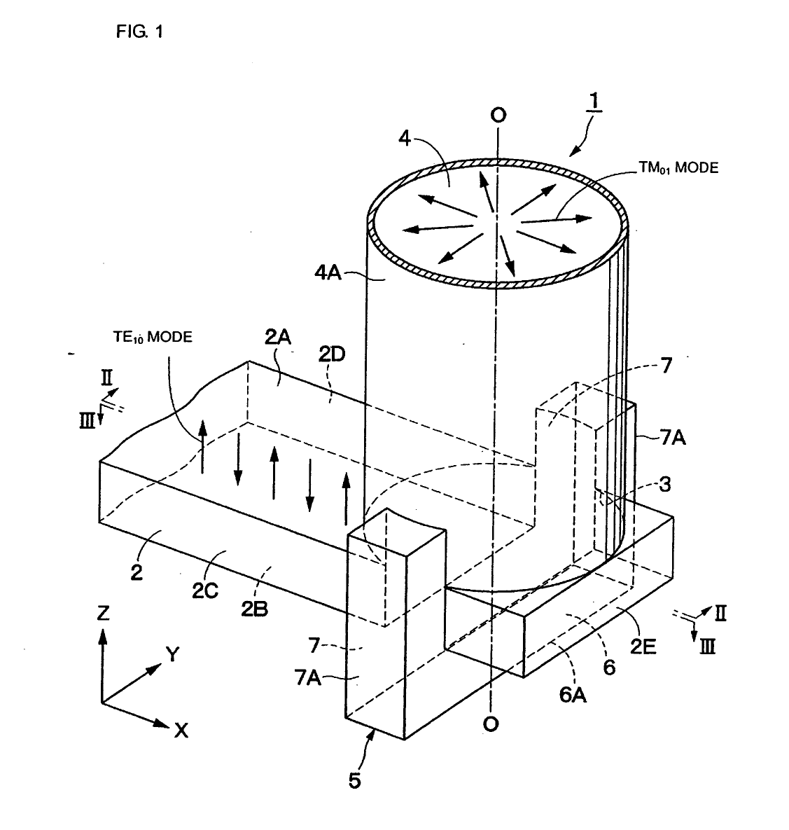

FIGS. 1 to 3 show a first embodiment. In FIGS. 1 to 3, reference numeral 1 denotes a waveguide conversion device. The waveguide conversion device 1 includes, for example, a rectangular waveguide 2, a circular waveguide 4, and an unnecessary-wave suppression groove 5 that are described below. The waveguide conversion device 1 transmits high frequency signals, for example, microwaves and millimeter waves.

The rectangular waveguide 2 is composed of, for example, a rectangular metal tube. The rectangular waveguide 2 transmits high frequency signals of the TE₁₀ mode and linearly extends along, for example, the X axis direction among the X, Y, and Z axes that are mutually perpendicular to each other. The cross-sectional shape of the rectangular waveguide 2 is a rectangle that is long in the Y axis direction.

The rectangular waveguide 2 includes upper and lower tube walls 2A and 2B that oppose each other in the Z axis direction, left and right tube walls 2C and 2D that oppose each other in the Y axis direction, and another tube wall 2E that is connected to ends of the tube walls 2A to 2D and blocks an end of the rectangular waveguide 2.

In this case, the upper and lower tube walls 2A and 2B constitute an H plane for the TE₁₀ mode. A circular aperture 3 for connecting the circular waveguide 4 is provided on the side of an end of the upper tube wall 2A.

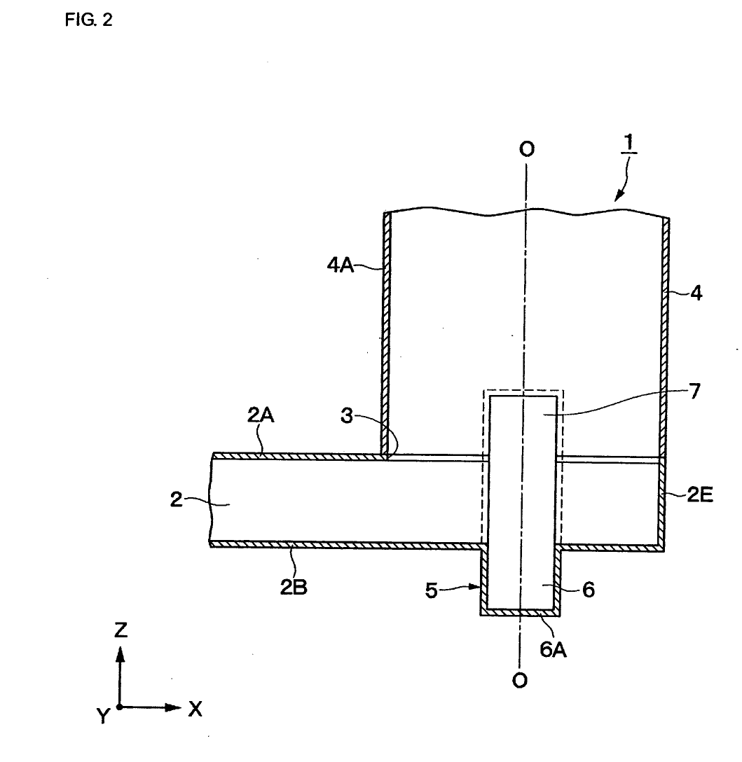

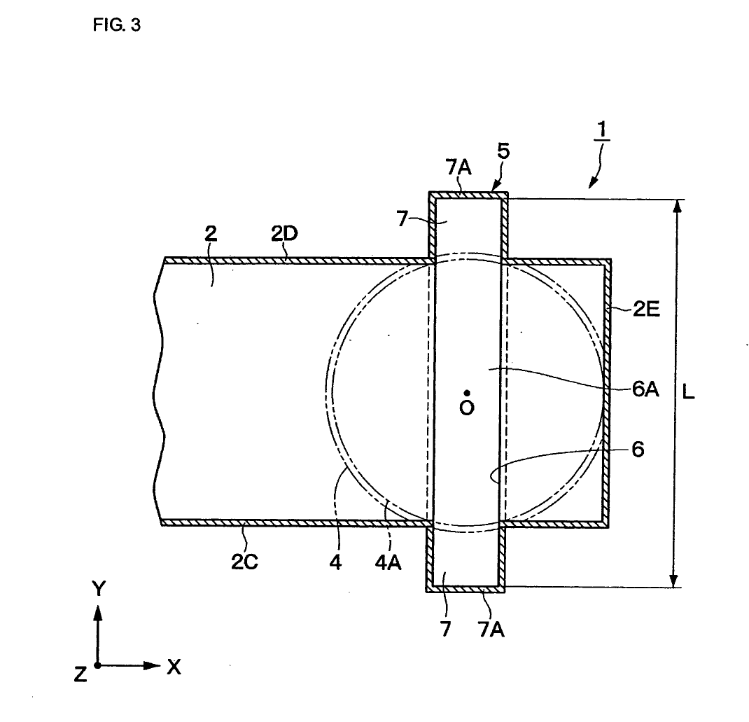

The circular waveguide 4 is connected to the aperture 3 of the rectangular waveguide 2 and transmits high frequency signals of the TM₀₁ mode. The circular waveguide 4 is composed of, for example, a metal tube that has a circular cross-sectional shape, and a tube wall 4A of the circular waveguide 4 has an axis O-O (a center O), as shown in FIGS. 2 and 3. The circular waveguide 4 extends along the Z axis direction and is perpendicular to the H plane (the tube wall 2A) of the rectangular waveguide 2.

The unnecessary-wave suppression groove 5 composed of, for example, a metallic material is provided at a mode conversion part between the rectangular waveguide 2 and the circular waveguide 4. The unnecessary-wave suppression groove 5 prevents an unnecessary transmission mode, for example, the circular TE₁₁ mode, from being excited in the circular waveguide 4 to efficiently convert the electric field component of the rectangular TE₁₀ mode that transmits through the rectangular waveguide 2 to the electric field component of the circular TM₀₁ mode that transmits thorough the circular waveguide 4, as described below, when high frequency signals are transmitted from the rectangular waveguide 2 to the circular waveguide 4.

The unnecessary-wave suppression groove 5 is provided as, for example, a long groove that extends so as to surround the outside of the rectangular waveguide 2 and form an approximately U-shaped structure, and the cross section of the unnecessary-wave suppression groove 5 has a rectangular shape. The unnecessary-wave suppression groove 5 extends along the tube walls 2B, 2C, and 2D corresponding to three sides among four sides of the cross section of the rectangular waveguide 2 and is also provided on the tube wall 4A of the circular waveguide 4.

That is to say, the unnecessary-wave suppression groove 5 includes a horizontal groove 6 that extends in the Y axis direction along the lower tube wall 2B of the rectangular waveguide 2 and left and right vertical grooves 7 that bend from the both ends of the horizontal groove 6 in an L shape and extend in the Z axis direction along the tube walls 2C and 2D of the rectangular waveguide 2 and the tube wall 4A of the circular waveguide 4.

In this case, the horizontal groove 6 includes a bottom surface 6A that is recessed from the tube wall 2B of the rectangular waveguide 2. The left vertical groove 7 includes a bottom surface 7A that is recessed from the left tube wall 2C of the rectangular waveguide 2 (the tube wall 4A of the circular waveguide 4), and the right vertical groove 7 similarly includes another bottom surface 7A that is recessed from the tube walls 2D and 4A.

Moreover, the unnecessary-wave suppression groove 5 is disposed at a position corresponding to the axis O-O of the circular waveguide 4 (in this embodiment, for example, a position on the axis O-O) and extends in the direction (for example, the Y axis direction) perpendicular to the direction of the electric field component of, for example, an unnecessary TE₁₁ mode that is excited in the circular waveguide 4, as shown in FIGS. 2 and 3.

The length L (the distance between the bottom surfaces 7A of the vertical grooves 7) of the unnecessary-wave suppression groove 5 in the Y axis direction is set so that, for example, the length L is equal to or more than one half of a wavelength X where the wavelength X is the length of one wave of high frequency signals that are transmitted between the waveguides 2 and 4, as shown by the following Expression 1.
L≧λ/2 [E1]

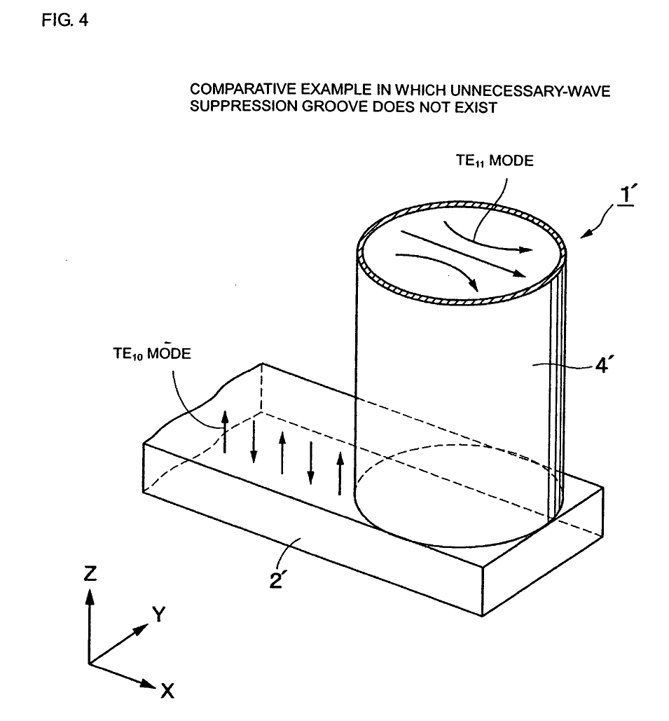

In this case, when signals are transmitted from the rectangular waveguide 2 to the circular waveguide 4, the TE₁₁ mode, which is an unnecessary transmission mode, is readily excited in the X axis direction along the direction in which the rectangular waveguide 2 (a waveguide 2′) extends, as shown below in FIG. 4. The short-circuited end of the TE₁₁ mode that is excited in this direction is, for example, located at the bottom surface 6A of the horizontal groove 6 in the unnecessary-wave suppression groove 5.

In this embodiment, the unnecessary-wave suppression groove 5 functioning as a reactive element is provided at the mode conversion part, which performs transmission mode conversion between the rectangular waveguide 2 and the circular waveguide 4, and the dimensions, shape, and placement of the unnecessary-wave suppression groove 5 are appropriately set, as described above. Thus, the waveguide conversion device 1 is constructed so that the electric field component of the TE₁₀ mode that transmits through the rectangular waveguide 2 does not match the electric field component of the unnecessary TE₁₁ mode that is generated in the circular waveguide 4 but matches the electric field component of the TM₀₁ mode that needs to be transmitted.

The waveguide conversion device 1 according to this embodiment has the aforementioned structure. The operation of the waveguide conversion device 1 will now be described.

When electromagnetic waves of the TE₁₀ mode that transmit through the rectangular waveguide 2 are transmitted to the circular waveguide 4, the transmission mode is converted at the mode conversion part at which the rectangular waveguide 2 and the circular waveguide 4 intersect each other. In this case, in the circular waveguide 4, the TE₁₁ mode, which is an unnecessary transmission mode, is the fundamental transmission mode, and the TM₀₁ mode, which is a regular transmission mode to be transmitted, is the secondary transmission mode.

Thus, for example, in an arrangement shown by a comparative example in FIG. 4 in which the rectangular waveguide 2′ and a circular waveguide 4′ in a waveguide conversion device 1′ are merely connected to each other without the unnecessary-wave suppression groove 5, the unnecessary TE₁₁ mode is readily excited in the circular waveguide 4+ by electromagnetic waves of the TE₁₀ mode that transmit through the rectangular waveguide 2′. As a result, in the arrangement of the comparative example, signal conversion loss in the regular TM₀₁ mode is increased, which may result in, for example, decreased transmission efficiency and degradation in signal characteristics.

In contrast, in this embodiment, since the unnecessary-wave suppression groove 5 is provided at the mode conversion part between the rectangular waveguide 2 and the circular waveguide 4, the unnecessary TE₁₁ mode can be prevented by the unnecessary-wave suppression groove 5 from being excited in the circular waveguide 4. Thus, electromagnetic waves of the TM₀₁ mode can be efficiently excited in the circular waveguide 4 by electromagnetic waves of the TE₁₀ mode that transmit through the rectangular waveguide 2, and mode conversion between the TE₁₀ mode and the TM₀₁ mode can be stably performed with low loss.

In this way, in this embodiment, the unnecessary-wave suppression groove 5 is provided at the mode conversion part between the rectangular waveguide 2 and the circular waveguide 4. Thus, when high frequency signals are transmitted between the waveguides 2 and 4, for example, an unnecessary transmission mode, such as the TE₁₁ mode, is prevented from being excited together with the necessary TM₀₁ mode, and only a necessary transmission mode can be stably transmitted.

Thus, for example, resonance can be prevented from being generated in the circular waveguide 4, in which mode conversion is performed, due to an unnecessary transmission mode by appropriately setting, for example, the dimensions, shape, and placement of the unnecessary-wave suppression groove 5 in advance. Accordingly, signal loss can be decreased, and, for example, transmission efficiency and signal characteristics can be improved.

In this case, the unnecessary-wave suppression groove 5 extends over the rectangular waveguide 2 and the circular waveguide 4 in the Y axis direction that is perpendicular to the electric field component of the unnecessary TE₁₁ mode, and the length L of the unnecessary-wave suppression groove 5 is set so as to be equal to or more than one half of the wavelength λ of one wave of high frequency signals (L≧λ/2). Thus, the unnecessary-wave suppression groove 5 can be disposed so as to cover a sufficient area, and an unnecessary transmission mode can be stably suppressed by appropriately setting the placement of the unnecessary-wave suppression groove 5.

Thus, a transmission state can be achieved, in which the transmission mode (the TE₁₀ mode) of electromagnetic waves that transmit through the rectangular waveguide 2 matches only the TM₀₁ mode required in the circular waveguide 4 and does not match the unnecessary TE₁₁ mode. Accordingly, a strong effect of suppressing the unnecessary transmission mode can be achieved.

Moreover, since the rectangular waveguide 2 is provided with the unnecessary-wave suppression groove 5 at a position corresponding to the axis O-O of the circular waveguide 4, the unnecessary-wave suppression groove 5 can be accurately disposed at the mode conversion part between the waveguides 2 and 4 with respect to the axis O-O. Thus, the part shape, structure, and the like of the circular waveguide 4 that is not provided with the unnecessary-wave suppression groove 5 can be simplified, the circular waveguide 4 can be readily formed, and the productivity in this case can be high compared with the productivity in a case where both of the waveguides 2 and 4 are provided with the unnecessary-wave suppression groove.

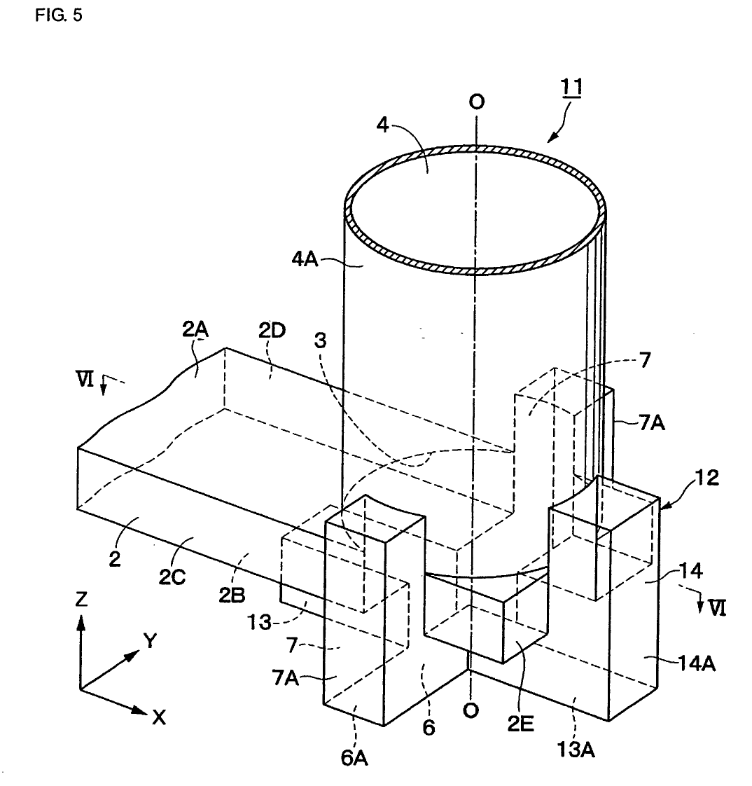

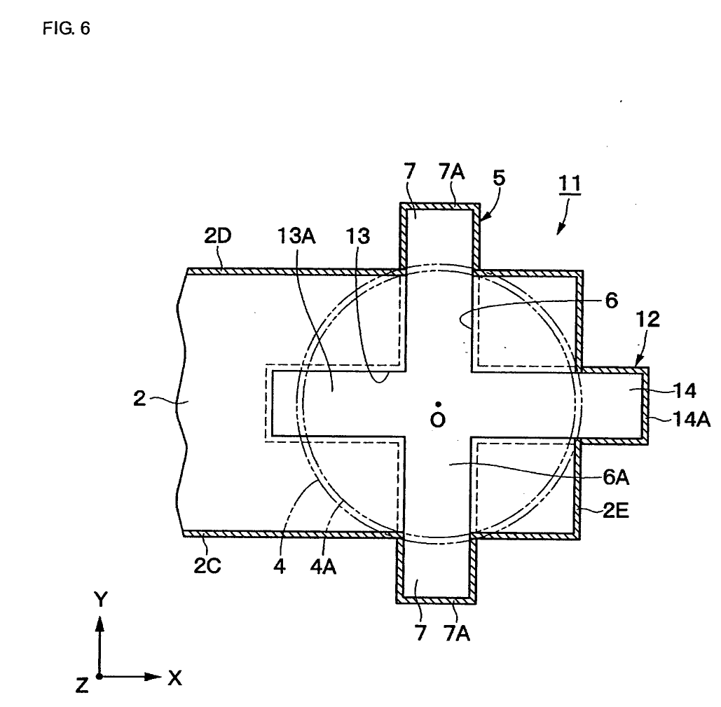

Next, FIGS. 5 and 6 show a second embodiment according to the present invention. This embodiment is characterized in that a plurality of unnecessary-wave suppression grooves are provided. In this embodiment, the same reference numerals and letters as in the first embodiment are assigned to the corresponding components, and the description of these components is omitted.

Reference numeral 11 denotes a waveguide conversion device. The waveguide conversion device 11 includes the rectangular waveguide 2, the circular waveguide 4, the unnecessary-wave suppression groove 5, and the like, similarly in the first embodiment. However, another unnecessary-wave suppression groove 12 that is described below is provided at the mode conversion part at which the rectangular waveguide 2 and the circular waveguide 4 intersect each other.

The unnecessary-wave suppression groove 12 is another unnecessary-wave suppression groove that is, together with the unnecessary-wave suppression groove 5, provided in the waveguides 2 and 4. The unnecessary-wave suppression groove 12 suppresses, for example, the TE₁₁ mode that is excited in the direction that is different from the direction (the X axis direction) in which the rectangular waveguide 2 extends.

For example, the unnecessary-wave suppression groove 12 is disposed at a position corresponding to the center O of the circular waveguide 4 so as to intersect (cross at right angles) the unnecessary-wave suppression groove 5, extend in the X axis direction, and form an L-shaped structure over the tube walls 2B and 2E of the rectangular waveguide 2 and the tube wall 4A of the circular waveguide 4, as shown in FIG. 6.

In this case, the unnecessary-wave suppression groove 12 includes a horizontal groove 13 that extends in the X axis direction along the lower tube wall 2B of the rectangular waveguide 2 and a vertical groove 14 that bends from an end of the horizontal groove 13 in an L shape and extends in the Z axis direction along the tube wall 2E of the rectangular waveguide 2 and the tube wall 4A of the circular waveguide 4. The horizontal groove 13 includes a bottom surface 13A that is recessed from the tube wall 2B of the rectangular waveguide 2, and the vertical groove 14 includes a bottom surface 14A that is recessed from the tube walls 2E and 4A.

In this embodiment that has such structure, substantially the same advantages as in the first embodiment can be achieved. In particular, in this embodiment, the two unnecessary-wave suppression grooves 5 and 12 are disposed so as to be mutually perpendicular to each other. Thus, even when, for example, the TE₁₁ mode that has an electric field component in the Y axis direction is excited other than the TE₁₁ mode (the TE₁₁ mode in the X axis direction) indicated by arrows in FIG. 4 in the first embodiment, these TE₁₁ modes can be stably suppressed with the unnecessary-wave suppression grooves 5 and 12. Thus, the transmission efficiency of a necessary transmission mode can be improved.

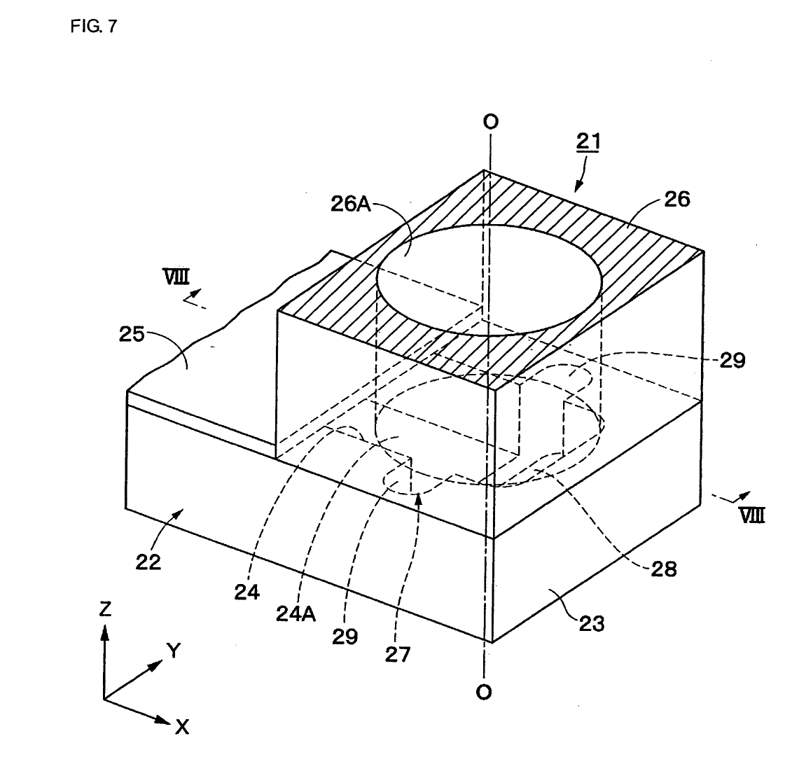

Next, FIGS. 7 to 11 show a third embodiment according to the present invention. This embodiment is characterized in that the waveguide conversion device is composed of a plurality of parts.

Reference numeral 21 denotes a waveguide conversion device. The waveguide conversion device 21 includes a rectangular waveguide 22, a circular waveguide 26, an unnecessary-wave suppression groove 27, and the like that are described below, substantially as in the first embodiment. In this case, the waveguides 22 and 26 are formed as separate parts.

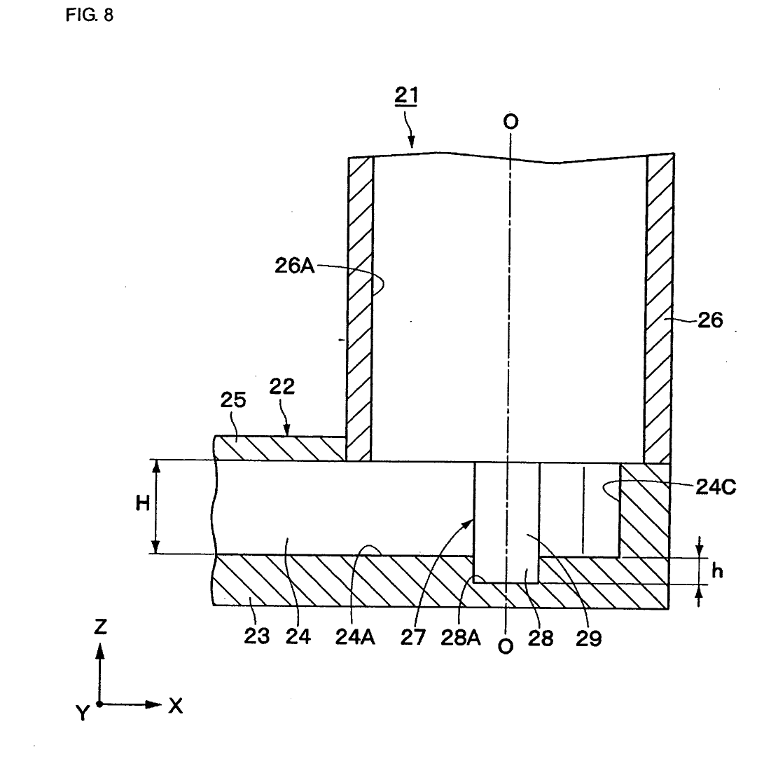

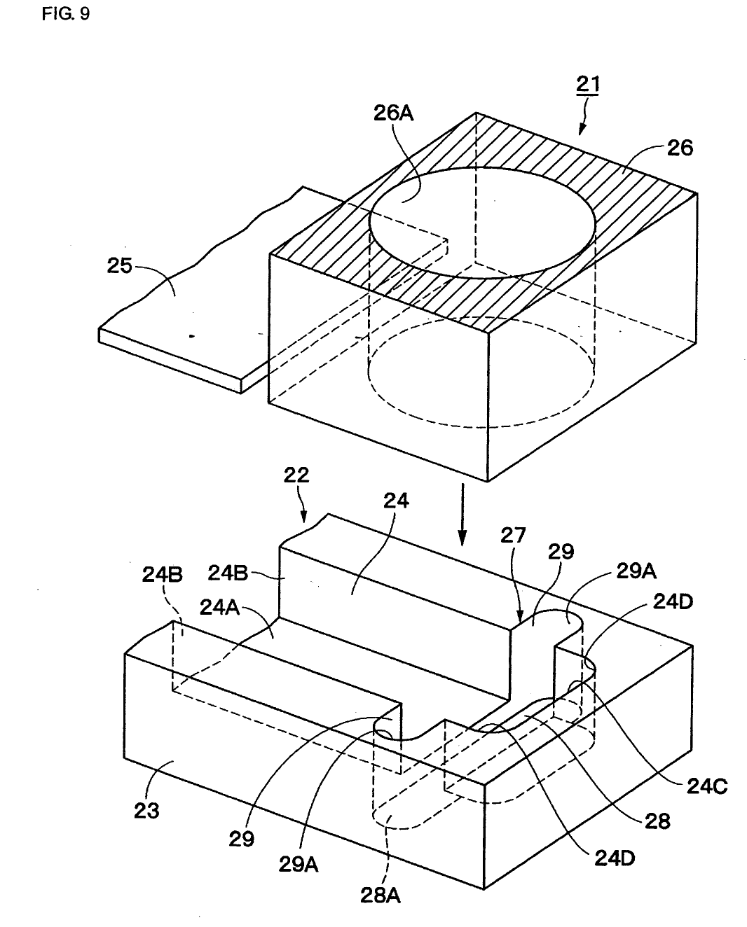

The rectangular waveguide 22 extends in the X axis direction and is formed by, for example, assembling together a waveguide part 23 composed of, for example, an elongated box-like metallic member and a cover plate 25 that is described below, as shown in FIGS. 8 and 9.

The waveguide part 23 includes a long groove 24 that has a rectangular cross-sectional shape. The long groove 24 linearly extends in the X axis direction and is open toward the abutting surface (the upper surface in FIG. 7) of the waveguide part 23, the abutting surface abutting the circular waveguide 26. The long groove 24 includes a bottom surface 24A, left and right side surfaces 24B, and an end surface 24C that blocks one end of the long groove 24 in the longitudinal direction.

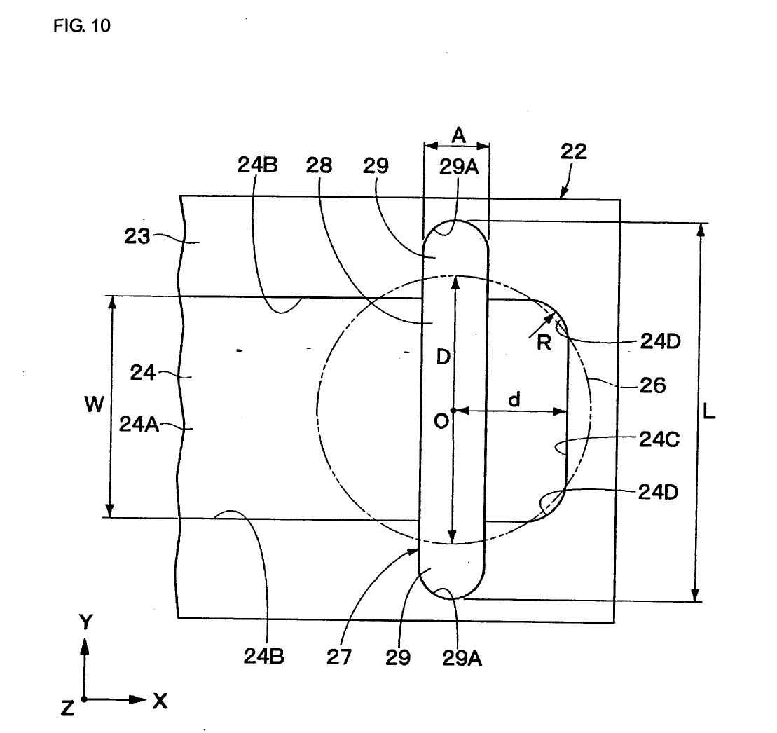

The corners of the long groove 24 at the end surface 24C side are, for example, concave curved surfaces 24D that are formed so as to be rounded to improve the processability of the waveguide part 23, as shown in FIG. 10. Moreover, the waveguide part 23 includes the unnecessary-wave suppression groove 27, which is described below.

The cover plate 25 is composed of, for example, a metallic plate and, together with the circular waveguide 26, covers the long groove 24 of the waveguide part 23 to form the rectangular waveguide 22. In this case, the cover plate 25 is not limited to a plate. The cover plate 25 may be formed with the circular waveguide 26 as one piece.

The circular waveguide 26 is composed of, for example, a metallic material and includes a circular hole 26A that has a circular cross-sectional shape and linearly extends in the Z axis direction. The circular hole 26A has the axis O-O.

The circular waveguide 26 together with the cover plate 25 is constructed so as to abut the upper surface of the waveguide part 23 and is fixed at a predetermined position such that the circular hole 26A opposes the unnecessary-wave suppression groove 27, which is described below. In this state, the circular waveguide 26 is connected to an end of the rectangular waveguide 22 (the long groove 24) and extends in the direction perpendicular to the rectangular waveguide 22.

The unnecessary-wave suppression groove 27 is provided at the mode conversion part at which the rectangular waveguide 22 and the circular waveguide 26 intersect each other. The unnecessary-wave suppression groove 27 is, for example, a long groove that extends so as to form an approximately U-shaped structure, substantially as in the first embodiment, as shown in FIGS. 8 and 10. The unnecessary-wave suppression groove 27 extends along the bottom surface 24A and left and right side surfaces 24B of the long groove 24 of the waveguide part 23. In this case, only the rectangular waveguide 22 out of the waveguides 22 and 26 is provided with the unnecessary-wave suppression groove 27.

The unnecessary-wave suppression groove 27 is disposed at a position corresponding to the axis O-O of the circular waveguide 26 and extends in the Y axis direction. The length L of the unnecessary-wave suppression groove 27 is set so as to satisfy the Expression 1 that was described in the first embodiment.

The unnecessary-wave suppression groove 27 includes a horizontal groove 28 that extends in the Y axis direction along the bottom surface 24A at an end of the long groove 24 and left and right vertical grooves 29 that bend from the both ends of the horizontal groove 28 in an L shape and extend in the Z axis direction along the left and right side surfaces 24B of the long groove 24. The horizontal groove 28 has, for example, a rectangular cross-sectional shape and includes a bottom surface 28A that is recessed from the bottom surface 24A of the long groove 24.

The left and right vertical grooves 29 are formed so as to have, for example, an approximately U-shaped cross section. The bottom surfaces of the left and right vertical grooves 29 are concave curved surfaces 29A that are recessed from the side surfaces 24B of the long groove 24. In this case, ends of the grooves 29 in the Z axis direction are blocked by the circular waveguide 26 at the abutting surface of the waveguide part 23.

When high frequency signals are transmitted from the rectangular waveguide 22 to the circular waveguide 26, for example, the bottom surface 28A of the horizontal groove 28 functions as a short-circuited end for an unnecessary transmission mode, such as the TE₁₁ mode. Thus, the unnecessary-wave suppression groove 27 prevents the unnecessary transmission mode from being excited in the circular waveguide 26, substantially as in the first embodiment.

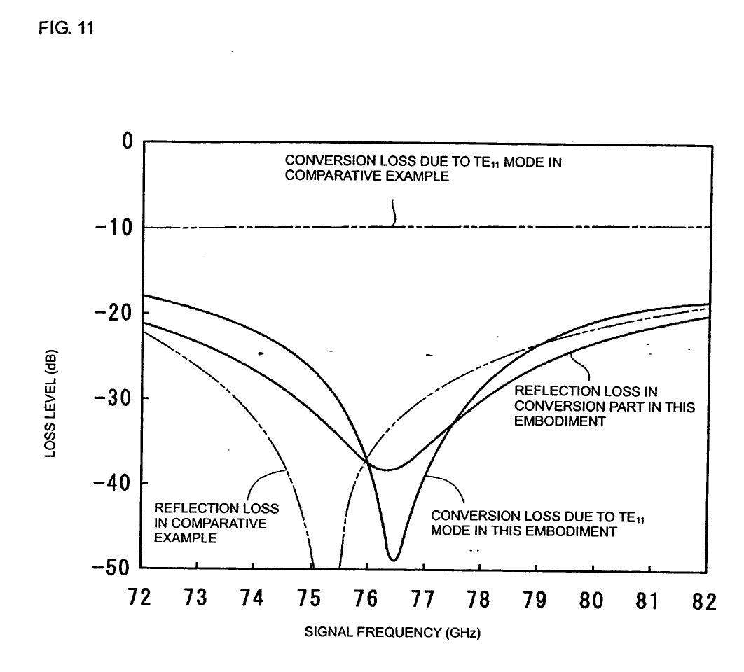

The transmission characteristics of high frequency signals of the waveguide conversion device 21 will now be described with reference to FIG. 11. Characteristic lines indicated by solid lines in FIG. 11 show the results of simulating the transmission characteristics. The set conditions of the simulation are, for example, the width W=2.54 mm and height H=1.27 mm of the rectangular waveguide 22, the radius of curvature R=0.5 mm of the concave curved surfaces 24D of the long groove 24, the diameter D=3.5 mm of the circular waveguide 26, and the distance d=1.55 mm between the center O of the circular waveguide 26 and the short-circuited surface (the end surface 24C of the long groove 24) of the rectangular waveguide 22, as shown in FIGS. 8 and 10. The other set conditions are the length L=5.14 mm, groove width A=1.00 mm of the unnecessary-wave suppression groove 27 and the depth h=0.4 mm of the horizontal groove 28.

On the other hand, characteristic lines indicated by imaginary lines in FIG. 11 show the results of performing the same simulation in the waveguide conversion device 1′ (see FIG. 4), which was described as the comparative example in the first embodiment.

As is apparent from the characteristic lines of the comparative example, when transmission mode conversion is performed in the waveguide conversion device 1′, high-level conversion loss, for example, −10 dB, occurs over a wide frequency range because the unnecessary TE₁₁ mode is excited. Moreover, reflection loss in the conversion part occurs to some degree.

In contrast, in this embodiment, the dimensions, shape, placement, and the like of the unnecessary-wave suppression groove 27 are appropriately set. Thus, conversion loss due to the unnecessary TE₁₁ mode can be minimized while reflection loss is maintained at a low level substantially as in the comparative example.

In particular, at frequencies of, for example, about 75 to 78 GHz that are used in the waveguide conversion device 21, conversion loss due to the TE₁₁ mode can be sufficiently reduced by the unnecessary-wave suppression groove 27. Thus, electromagnetic waves of the TE₁₀ mode that transmit through the rectangular waveguide 22 can be efficiently converted to electromagnetic waves of the TM₀₁ mode in the circular waveguide 26.

In this embodiment that has the aforementioned structure, substantially the same advantages as in the first embodiment can be achieved. In particular, in this embodiment, the waveguide conversion device 21 is formed by assembling the waveguide part 23, the cover plate 25, the circular waveguide 26, and the like. Thus, even when the waveguides 22 and 26, the unnecessary-wave suppression groove 27, and the like have a complicated shape, these components can be readily formed with these components being divided into a plurality of parts, and the waveguide conversion device 21 can be efficiently fabricated by assembling the individual parts.

In this case, since the horizontal groove 28 and the vertical grooves 29 of the unnecessary-wave suppression groove 27 are formed only in the rectangular waveguide 22 (the waveguide part 23), the shape and structure of the circular waveguide 26 can be simplified. Thus, the circular waveguide 26 can be readily formed.

Moreover, in the waveguide part 23, for example, the concave curved surfaces 24D and 29A are respectively formed in the long groove 24 and the vertical grooves 29 without affecting effect of suppressing the unnecessary TE₁₁ mode. Thus, the productivity can be improved.

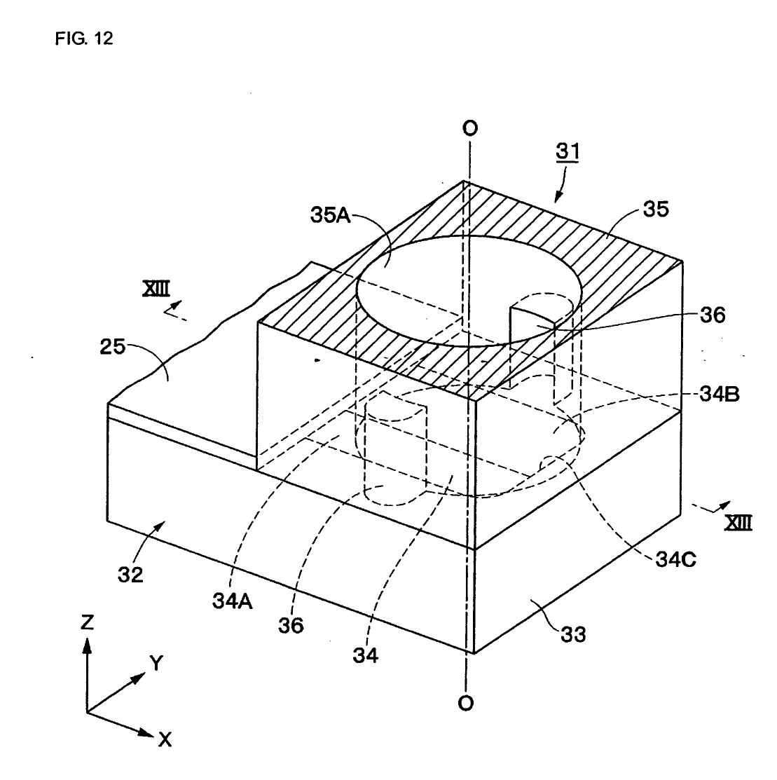

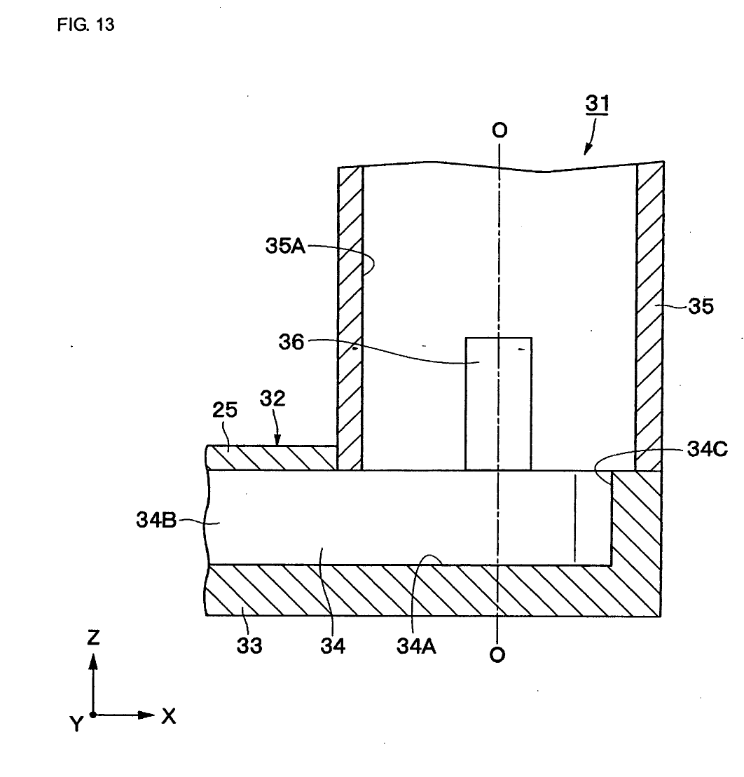

Next, FIGS. 12 and 13 show a fourth embodiment according to the present invention. This embodiment is characterized in that the rectangular waveguide does not include the unnecessary-wave suppression groove but only the circular waveguide includes the unnecessary-wave suppression groove. In this embodiment, the same reference numerals and letters as in the third embodiment are assigned to the corresponding components, and the description of these components is omitted.

Reference numeral 31 denotes a waveguide conversion device. The waveguide conversion device 31 includes a rectangular waveguide 32, a circular waveguide 35, unnecessary-wave suppression grooves 36, and the like that are described below, substantially as in the third embodiment. The waveguides 32 and 35 are formed as separate parts.

The rectangular waveguide 32 is formed by assembling a waveguide part 33 and the cover plate 25, substantially as in the third embodiment, as shown in FIGS. 12 and 13. The waveguide part 33 includes a long groove 34 that includes, for example, a bottom surface 34A, left and right side surfaces 34B, and an end surface 34C.

The circular waveguide 35 is composed of, for example, a metallic material and includes a circular hole 35A that extends along the axis O-O that extends in the Z axis direction, substantially as in the third embodiment. The unnecessary-wave suppression grooves 36, which are described below, are provided in portions of the peripheral wall at the both sides of a diameter of the circular hole 35A.

The unnecessary-wave suppression grooves 36 are, for example, two unnecessary-wave suppression grooves that are provided at the mode conversion part at which the rectangular waveguide 32 and the circular waveguide 35 intersect each other. The unnecessary-wave suppression grooves 36 are formed so as to have, for example, an approximately U-shaped cross section and extend in the Z axis direction. In this case, only the circular waveguide 35 out of the waveguides 32 and 35 is provided with the unnecessary-wave suppression grooves 36. Ends of the unnecessary-wave suppression grooves 36 are blocked by the waveguide part 33 at the abutting surface of the circular waveguide 35.

In this embodiment that has the aforementioned structure, substantially the same advantages as in the first and third embodiments can be achieved. In particular, in this embodiment, since the unnecessary-wave suppression grooves 36 are formed only in the circular waveguide 35, the shape and structure of the rectangular waveguide 32 (the waveguide part 33) can be simplified. Thus, the rectangular waveguide 32 can be readily formed.

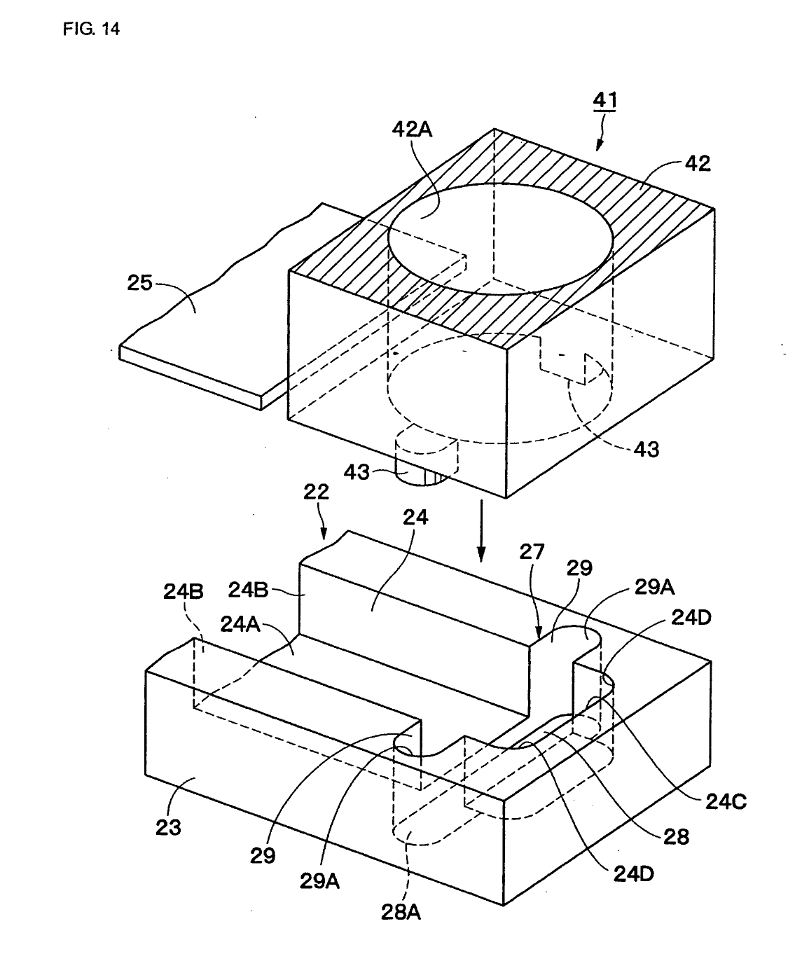

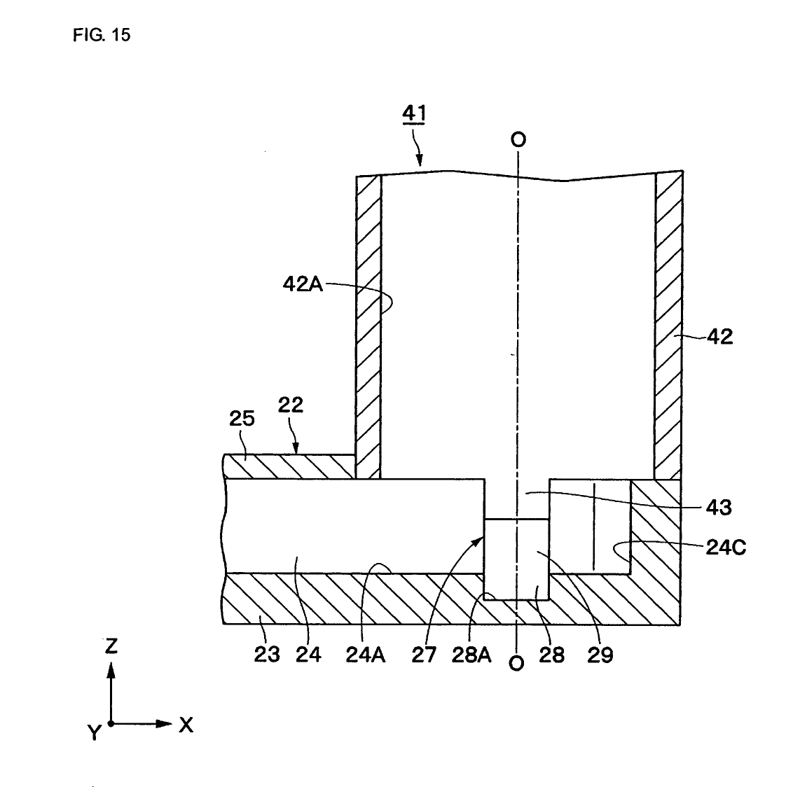

Next, FIGS. 14 and 15 show a fifth embodiment according to the present invention. This embodiment is characterized in that alignment parts are provided between a rectangular waveguide and a circular waveguide. In this embodiment, the same reference numerals and letters as in the third embodiment are assigned to the corresponding components, and the description of these components is omitted.

Reference numeral 41 denotes a waveguide conversion device. The waveguide conversion device 41 includes the rectangular waveguide 22, a circular waveguide 42, the unnecessary-wave suppression groove 27, and the like, substantially as in the third embodiment. The waveguides 22 and 42 are formed as separate parts.

The circular waveguide 42 is composed of, for example, a rectangular metallic member and includes a circular hole 42A that has the axis O-O and extends in the Z axis direction. Fitting protrusions 43 that are described below are provided on the abutting surface of the circular waveguide 42 that abuts the waveguide part 23.

The fitting protrusions 43 are, for example, two fitting protrusions that function as alignment parts that are provided on the circular waveguide 42. The individual fitting protrusions 43 are provided at, for example, at the both sides of a diameter of the circular hole 42A of the circular waveguide 42 and protrude toward the individual vertical grooves 29 of the waveguide part 23 in the Z axis direction. In this case, the fitting protrusions 43 have, for example, substantially the same approximately U-shaped cross section as the vertical grooves 29.

When the waveguides 22 and 42 are connected to each other by putting the waveguide part 23 to the circular waveguide 42, the fitting protrusions 43 are inserted into parts of the vertical grooves 29 of the unnecessary-wave suppression groove 27, as shown in FIG. 15. In this arrangement, the fitting protrusions 43 align the rectangular waveguide 22 with the circular waveguide 42.

In this embodiment that has the aforementioned structure, substantially the same advantages as in the first and third embodiments can be achieved. In particular, in this embodiment, since the fitting protrusions 43 are provided on the circular waveguide 42, the fitting protrusions 43 of the circular waveguide 42 can be inserted into parts of the vertical grooves 29 of the waveguide part 23 when the rectangular waveguide 22 is connected to the circular waveguide 42. Thus, the waveguides 22 and 42 can be accurately aligned with each other with the fitting protrusions 43.

Thus, the waveguide conversion device 41 that has accurate dimensions can be readily fabricated through the use of parts of the unnecessary-wave suppression groove 27, and effect of suppressing an unnecessary transmission mode can be improved.

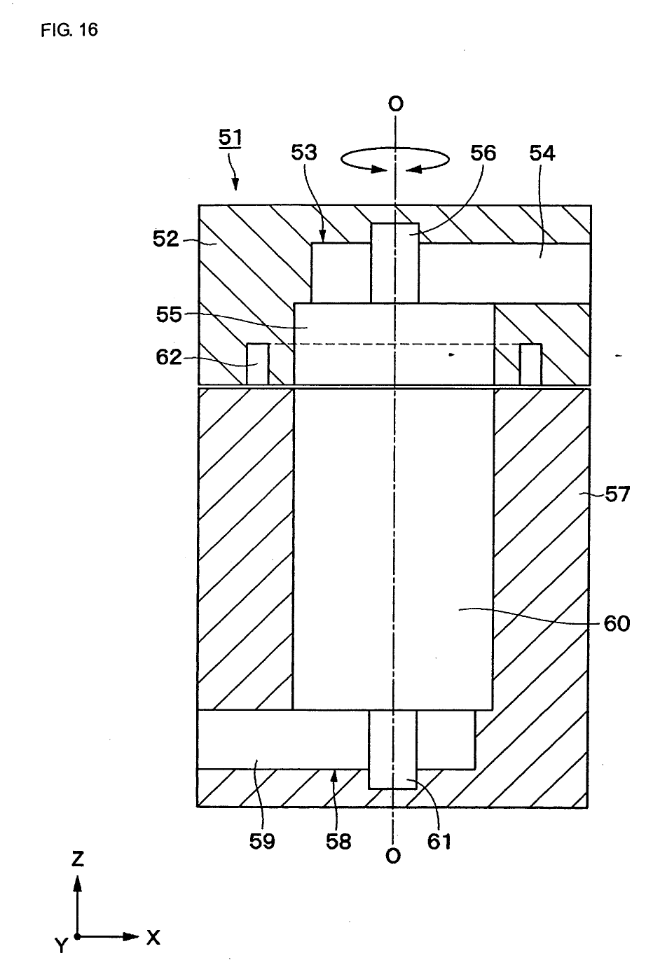

Next, FIG. 16 shows a sixth embodiment according to the present invention. This embodiment is characterized in that a waveguide rotary joint is embodied.

Reference numeral 51 denotes a waveguide rotary joint. The waveguide rotary joint 51 includes joint parts 52 and 57, waveguide conversion devices 53 and 58, and the like that are described below. In the waveguide rotary joint 51, the waveguide conversion devices 53 and 58 are connected to each other so that the waveguide conversion devices 53 and 58 can rotate with respect to each other, and high frequency signals are transmitted between the waveguide conversion devices 53 and 58 in a satisfactory condition.

Reference numeral 52 denotes one joint part that constitutes the waveguide rotary joint 51. The joint part 52 is composed of, for example, a metallic material and includes the waveguide conversion device 53. In this case, the waveguide conversion device 53 includes a rectangular waveguide 54, a circular waveguide 55, an unnecessary-wave suppression groove 56, and the like, substantially as in the third embodiment.

Reference numeral 57 denotes the other joint part that constitutes the waveguide rotary joint 51. The joint part 57 is composed of, for example, a metallic material and includes the waveguide conversion device 58. In this case, the waveguide conversion device 58 includes a rectangular waveguide 59, a circular waveguide 60, an unnecessary-wave suppression groove 61, and the like, as in the one waveguide conversion device 53.

The joint parts 52 and 57 abut each other with a minute gap therebetween with the circular waveguides 55 and 60 being disposed on the same axis. The joint parts 52 and 57 are connected to each other so that the joint parts 52 and 57 can rotate with their centers on the axis O-O of the circular waveguides 55 and 60. In this case, for example, a circular gap that surrounds the circular waveguide 55 from the outside in the radial direction is provided in the joint part 52. This gap serves as a choke 62 that prevents leakage of electromagnetic waves.

In this embodiment that has the aforementioned structure, substantially the same advantages as in the first and third embodiments can be achieved. In particular, in this embodiment, since the waveguide conversion devices 53 and 58 constitute the waveguide rotary joint 51, the circular waveguides 55 and 60 of the waveguide conversion devices 53 and 58 can be connected to each other with the circular waveguides 55 and 60 being disposed on the same axis so as to be rotatable. Thus, the circular waveguides 55 and 60 can respectively convert in a satisfactory condition the transmission mode of signals between the circular waveguide 55 and the rectangular waveguide 54 and between the circular waveguide 60 and the rectangular waveguide 59 through the use of the unnecessary-wave suppression grooves 56 and 61.

In this case, the electric field component of the TM₀₁ mode that transmits through the circular waveguides 55 and 60 is symmetric with respect to the axis (the center of rotation) of the waveguides 55 and 60. Thus, even when the waveguides 55 and 60 rotate with respect to each other with their centers on the axis O-O, the TM₀₁ mode can be stably transmitted between the waveguides 55 and 60.

Thus, the rectangular waveguides 54 and 59 of the individual waveguide conversion devices 53 and 58 can smoothly transmit high frequency signals therebetween with the rectangular waveguides 54 and 59 rotating with respect to each other. Accordingly, a highly versatile waveguide rotary joint 51 can be implemented, in which the signal transmission loss is small.

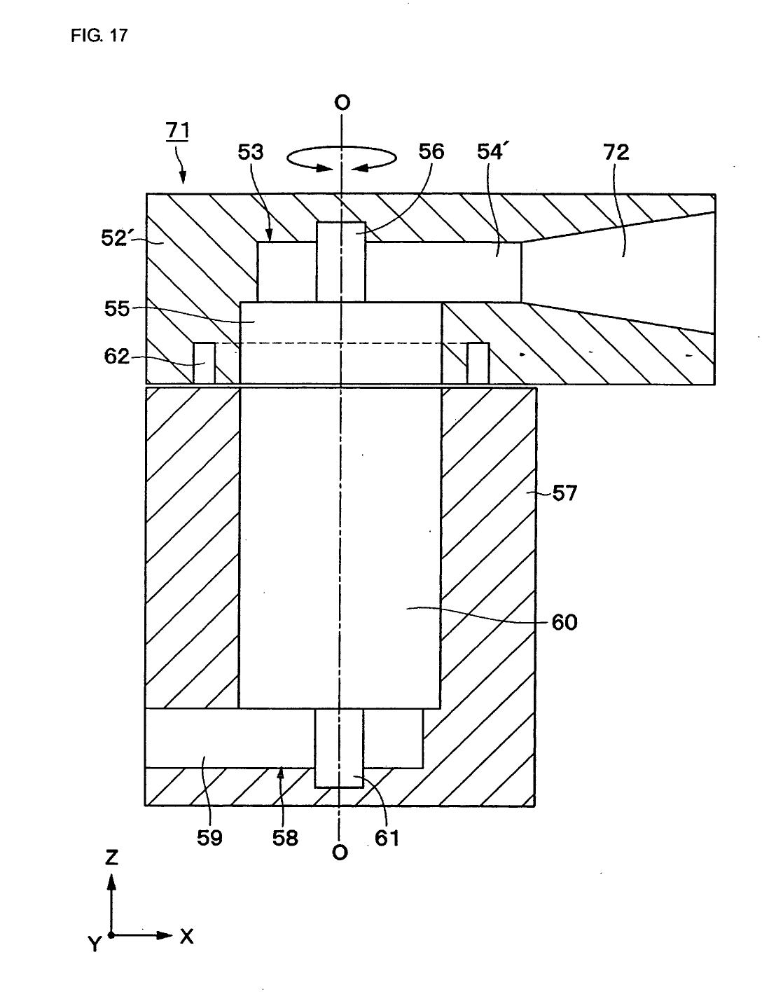

Next, FIG. 17 shows a seventh embodiment according to the present invention. This embodiment is characterized in that a rotary antenna device is embodied. In this embodiment, the same reference numerals and letters as in the sixth embodiment are assigned to the corresponding components, and the description of these components is omitted.

Reference numeral 71 denotes a rotary antenna device. The antenna device 71 includes joint parts 52′ and 57, the waveguide conversion devices 53 and 58, and the like, substantially as in the sixth embodiment. The joint part 52′ includes the waveguide conversion device 53 that includes a rectangular waveguide 54′, the circular waveguide 55, the unnecessary-wave suppression groove 56, and the like. A radiator 72 that is described below is connected to one end of the rectangular waveguide 54′ opposite to the other end on which the circular waveguide 55 is located.

The radiator 72 is a radiator for wireless communication that is provided in the joint part 52′. The radiator 72 is formed as an aperture that is open in an approximately conic or pyramidal shape from the one end of the rectangular waveguide 54′ toward the exterior space. The radiator 72 transmits electromagnetic waves that transmit through the rectangular waveguide 54′ to the exterior and receives electromagnetic waves from the exterior into the rectangular waveguide 54′.

In this embodiment that has the aforementioned structure, substantially the same advantages as in the first, third, and sixth embodiments can be achieved. In particular, in this embodiment, the waveguide conversion devices 53 and 58 constitute the antenna device 71. Thus, the radiator 72 at one side can be rotated with respect to the rectangular waveguide 59 at the other side by, for example, fixing the one joint part 57 and rotating the other joint part 52′. In this state, the radiator 72 at the one side can be stably connected to the rectangular waveguide 59 at the other side with the circular waveguides 55 and 60, the unnecessary-wave suppression grooves 56 and 61, and the like.

Thus, for example, radio signals can be smoothly transmitted and received by the rectangular waveguide 59 at the other side while the directivity of the radiator 72 is being changed in the rotation direction. Accordingly, a highly versatile rotary antenna device 71 can be implemented, in which the signal transmission loss is small.

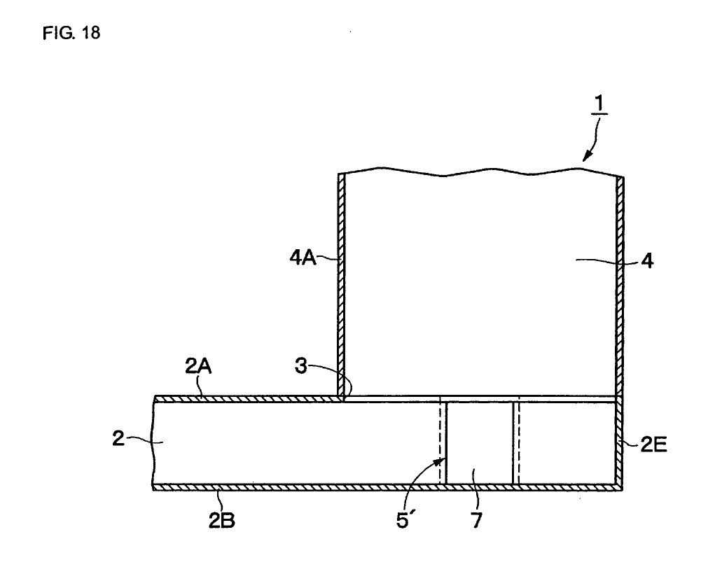

In the first embodiment, the unnecessary-wave suppression groove 5 extends along the tube walls 2B, 2C, and 2D of the rectangular waveguide 2 and the tube wall 4A of the circular waveguide 4. However, the present invention is not limited to this embodiment and may be embodied as, for example, a first modification shown in FIG. 18. In this case, unnecessary-wave suppression grooves 5′ are formed with only parts of the vertical grooves 7 in the first embodiment and extend along the left and right tube walls 2C and 2D of the rectangular waveguide 2.

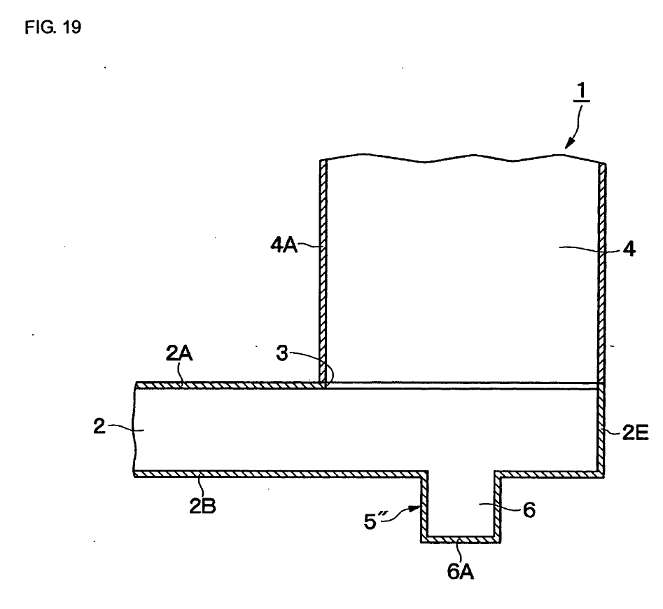

Moreover, the present invention may be embodied so that, for example, an unnecessary-wave suppression groove 5″ is formed with only the horizontal groove 6, the horizontal groove 6 being provided in a portion provided as the mode conversion part, the portion extends from the bottom of the rectangular waveguide 2 along the axis of the circular waveguide 4, as a second modification shown in FIG. 19. In this case, the unnecessary-wave suppression groove 5″ is formed with only the horizontal groove 6 in the first embodiment and extends along the lower tube wall 2B of the rectangular waveguide 2.

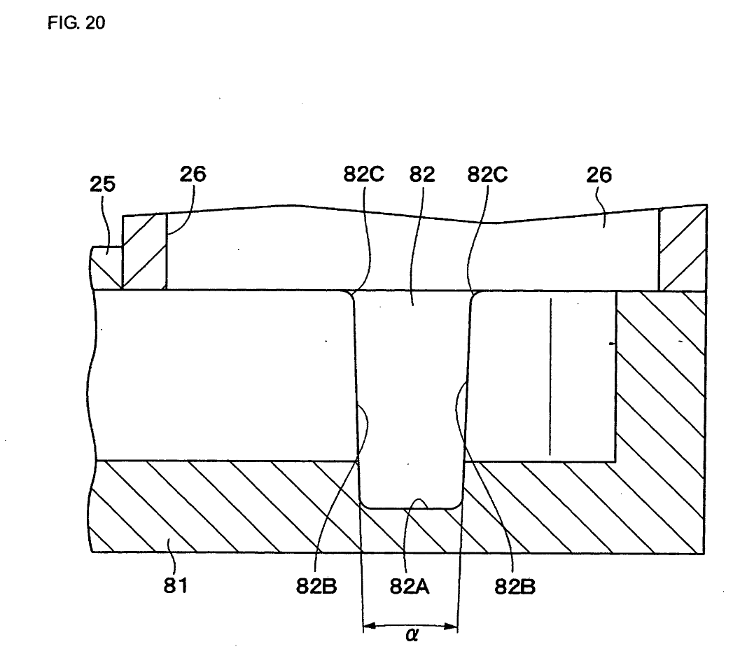

Moreover, in the third embodiment, the concave curved surfaces 24D and 29A are respectively provided in the long groove 24 and the vertical grooves 29 of the waveguide part 23. However, the present invention may be embodied as, for example, a third modification shown in FIG. 20 to improve efficiency in fabricating the waveguide part. In this case, vertical grooves 82 that are open toward the abutting surface of a waveguide part 81 are formed so that the groove width of the vertical grooves 82 at a bottom surface 82A is narrower than the groove width at the aperture side. Individual side surfaces 82B of the vertical grooves 82 are inclined at an angle of a and oppose each other. Moreover, chamfers 82C that have, for example, a convex curved or flat shape are provided at the aperture ends of the vertical grooves 82. Thus, for example, when the waveguide part 81 is formed by, for example, pressing or casting, the waveguide part 81 can be readily released from a die.

Moreover, in the fifth embodiment, the fitting protrusions 43 are provided on the circular waveguide 42 as the alignment parts of the waveguide conversion device 41. However, for example, alignment pins that are separate from the waveguide part and the circular waveguide may be used as the alignment parts in the present invention. For example, the alignment pins may be inserted into the waveguide part and the circular waveguide to align the waveguide part with the circular waveguide.

Moreover, the waveguide conversion devices 53 and 58 are used in the sixth and seventh embodiments, which are substantially the same as those in the third embodiment. However, the present invention is not limited to these embodiments. Needless to say, for example, the waveguide rotary joint or the antenna device may be composed of any of the waveguide conversion devices 1, 11, 31, and 41 according to the first, second, fourth, and fifth embodiments.

1. A waveguide conversion device comprising:
a rectangular waveguide;
a circular waveguide connected to the rectangular waveguide; and,
an unnecessary-wave suppression groove is provided in a mode conversion part between the rectangular waveguide and the circular waveguide, the unnecessary-wave suppression groove preventing an unnecessary transmission mode from being excited in the circular waveguide when signals are transmitted between the waveguides.

2. The waveguide conversion device according to claim 1, wherein the unnecessary-wave suppression groove is provided in either one or both of the rectangular waveguide and the circular waveguide and extends in a direction that is perpendicular to an electric field component of the unnecessary transmission mode.

3. The waveguide conversion device according to claim 1, wherein the unnecessary-wave suppression groove is provided in the rectangular waveguide at a position corresponding to an axis of the circular waveguide.

4. The waveguide conversion device according to claim 1, wherein the unnecessary-wave suppression groove is provided in the circular waveguide.

5. The waveguide conversion device according to claim 1, further comprising an alignment part is provided between the rectangular waveguide and the circular waveguide, to align the rectangular waveguide with the circular waveguide when the waveguides are connected to each other.

6. A waveguide rotary joint comprising:
a first waveguide conversion device, the first waveguide device including a first rectangular waveguide, a first circular waveguide connected to the first rectangular waveguide, and a first unnecessary-wave suppression groove provided in a mode conversion part between the first rectangular waveguide and the first circular waveguide, the first unnecessary-wave suppression groove preventing an unnecessary transmission mode from being excited in the first circular waveguide when signals are transmitted between the first rectangular waveguide and the first circular waveguide; and
a second waveguide conversion device, the second waveguide device including a second rectangular waveguide, a second circular waveguide connected to the second rectangular waveguide, and a second unnecessary-wave suppression groove provided in a mode conversion part between the second rectangular waveguide and the second circular waveguide, the second unnecessary-wave suppression groove preventing an unnecessary transmission mode from being excited in the second circular waveguide when signals are transmitted between the second rectangular waveguide and the second circular waveguide
wherein circular waveguides of the first and second waveguide conversion devices are disposed on a common axis and connected to each other so that the first and second circular waveguides are rotatable with respect to each other.

7. An antenna device comprising:
the waveguide rotary joint according to claim 6; and
a radiator for wireless communication connected to at least one of the first and second waveguide conversion devices.

8. The waveguide conversion device according to claim 1, wherein the rectangular waveguide transmits TE₁₀ mode signals; and the circular waveguide transmits TM₀₁ mode signals.

9. The waveguide conversion device according to claim 1, wherein the circular waveguide is connected to an H plane of the rectangular waveguide.

10. The waveguide conversion device according to claim 9, wherein the circular waveguide is connected to the rectangular waveguide at a right angle.

11. The waveguide conversion device according to claim 1, wherein the circular waveguide is connected to the rectangular waveguide at a right angle.

12. The waveguide conversion device according to claim 1, wherein the unnecessary transmission mode is a TE₁₁ mode.

13. The waveguide conversion device according to claim 1, wherein the unnecessary-wave suppression groove has a length of one half or more than one half of a length of one wave of the signals transmitted between the waveguides.

14. The waveguide conversion device according to claim 5, wherein the alignment part is inserted into a part of the unnecessary-wave suppression groove when the rectangular and circular waveguides are connected to each other.

15. The waveguide conversion device according to claim 1, wherein the unnecessary-wave suppression groove has a U-shaped structure.

16. The waveguide conversion device according to claim 1, wherein the unnecessary-wave suppression groove has a rectangular cross-section.

17. The waveguide conversion device according to claim 1, wherein the unnecessary-wave suppression groove is disposed at a position corresponding to a O-O axis of the circular waveguide.

18. The waveguide conversion device according to claim 1, wherein the unnecessary-wave suppression groove is a first unnecessary-wave suppression groove, and the waveguide conversion device further comprises a second unnecessary-wave suppression groove provided at the mode conversion part between the rectangular waveguide and the circular waveguide.

19. The waveguide conversion device according to claim 18, wherein the second unnecessary-wave suppression groove is disposed at a position corresponding to the center 0 axis of the circular waveguide and intersects the first groove.

20. The waveguide conversion device according to claim 18, wherein the first unnecessary-wave suppression groove is U-shaped and the second unnecessary-wave suppression groove is L-shaped.
